(19) United States
(12) Patent Application Publication
(10) Pub. No.: US 2010/0088495 A1
(43) Pub. Date: Apr. 8, 2010

(54) MODE-SPECIFIC CONTAINER RUNTIME ATTACHMENT

(75) Inventors: Chritopher L. Anderson, Redmond, WA (US); Anthony J. Moore, Seattle, WA (US); Vijaye G. Raji, Redmond, WA (US); Clemens A. Szyperski, Redmond, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 12/251,311

(22) Filed: Oct. 14, 2008

Related U.S. Application Data
(60) Provisional application No. 61/102,828, filed on Oct. 4, 2008.

(51) Int. Cl. G06F 9/318

(52) U.S. Cl. 712/229; 712/E09.035

(57) ABSTRACT

The operation of a multi-mode application. The multi-mode application has a number of mode-specific logical containers of components. Each mode-specific container contains components that assist the multi-mode application in operating in a corresponding mode. If the application transitions to another mode, the component(s) of the other corresponding mode-specific logical container is used to assist in operating in the other mode. The logical containers may be activated and deactivated during execution time as the application transitions from mode to mode.

### CROSS-REFERENCE TO RELATED APPLICATION

This patent application claims the benefit of co-pending commonly-assigned provisional patent application Ser. No. 61/102,828 filed Oct. 4, 2008, which provisional patent application is incorporated herein by reference in its entirety.

### BACKGROUND

In object-oriented programming, applications are composed of a collection of objects. As the application runs, the application may encounter a number of different modes of operation. Each mode will typically rely more heavily on some objects, and less so on others. Thus, as the application transitions from one mode of operation to another, the underlying usage of the constituent objects will also often change. For instance, in one operating mode, some objects may be used more than others. However, in another operating mode, those objects used more heavily in the first operating mode might now be used less frequently, or perhaps not at all. Thus, the constituent objects of an application exist to serve the greater function of the application as a whole. As the function of the application changes, the constituent objects supporting that function change.

### BRIEF SUMMARY

Embodiments described herein relate to the operation of a multi-mode application. The multi-mode application has a number of mode-specific logical containers of components. Each mode-specific container contains components that assist the multi-mode application in operating in a corresponding mode. If the application transitions to another mode, the component(s) of the other corresponding mode-specific logical container is used to assist in operating in the other mode. The logical containers may be activated and deactivated during execution time as the application transitions from mode to mode.

This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features can be obtained, a more particular description of various embodiments will be rendered by reference to the appended drawings. Understanding that these drawings depict only sample embodiments and are not therefore to be considered to be limiting of the scope of the invention, the embodiments will be described and explained with additional specificity and detail through the use of the accompanying drawings in which:

FIG. 1 illustrates a computing system that may execute a multi-mode application;

FIG. 2 schematically illustrates a multi-mode application in which each mode has a corresponding logical container of components that assist in the proper execution of the corresponding mode;

FIG. 3 illustrates a hierarchical structure of a logical containers from which the logical containers of FIG. 2 may be derived; and

FIG. 4 illustrates a flowchart of a method for operating a multi-mode application using logical containers for components that support each mode.

### DETAILED DESCRIPTION

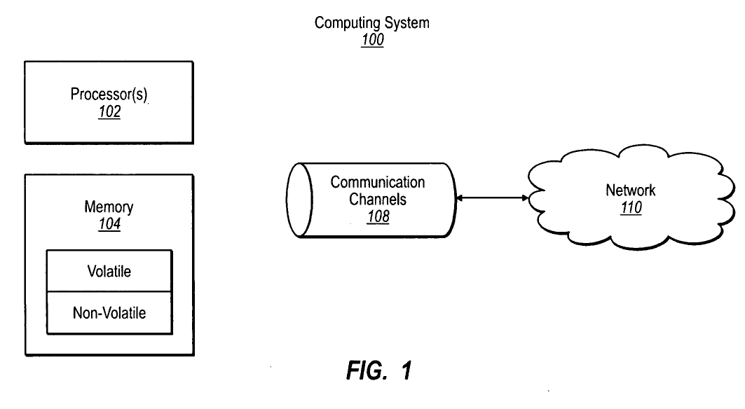

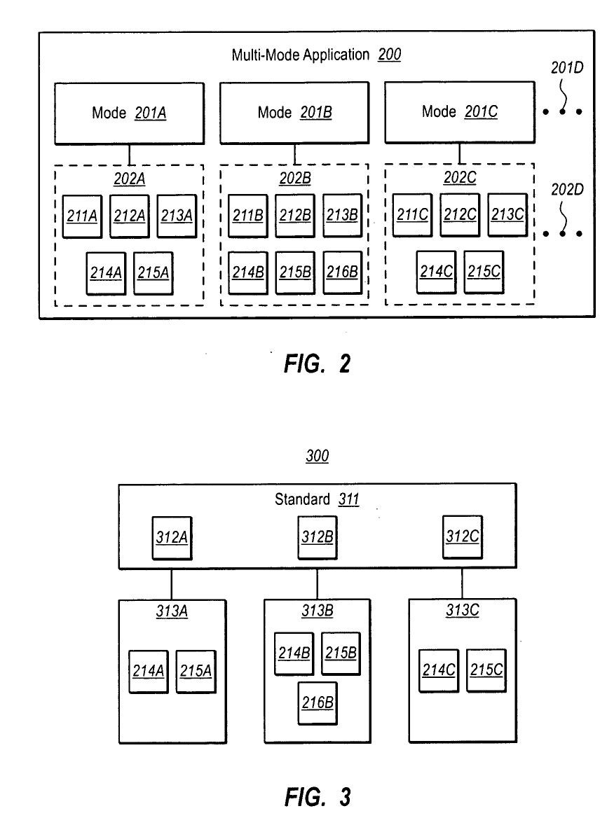

Embodiments described herein relate to the operation of a multi-mode application. First, a computing system that may be used to operate the multi-mode application will be described with respect to FIG. 1. Then, the operation of the multi-mode application will be described with respect to the subsequent FIGS. 2 through 4.

FIG. 1 illustrates a computing system 100. Computing systems are now increasingly taking a wide variety of forms. Computing systems may, for example, be handheld devices, appliances, laptop computers, desktop computers, mainframes, distributed computing systems, or even devices that have not conventionally considered a computing system. In this description and in the claims, the term “computing system” is defined broadly as including any device or system (or combination thereof) that includes at least one processor, and a memory capable of having thereon computer-executable instructions that may be executed by the processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well. As used herein, the term “module” or “component” can refer to software objects or routines that execute on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. An example of such an operation involves the manipulation of data. The computer-executable instructions (and the manipulated data) may be stored in the memory 104 of the computing system 100.

Computing system 100 may also contain communication channels 108 that allow the computing system 100 to communicate with other message processors over, for example, network 110. Communication channels 108 are examples of communications media. Communications media typically embody computer-readable instructions, data structures, program modules, or other data in a modulated data signal such as a carrier wave or other transport mechanism and include any information-delivery media. By way of example, and not limitation, communications media include wired media, such as wired networks and direct-wired connections, and wireless media such as acoustic, radio, infrared, and other wireless media. The term computer-readable media as used herein includes both storage media and communications media.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise physical storage and/or memory media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims.

FIG. 2 schematically illustrates a multi-mode application 200. The multi-mode application operates in multiple modes. For instance, the multi-mode application 200 operates in modes 201A, 201B and 201C. However, the horizontal ellipses 201D represents that the multi-mode application 200 may operate in any number of multiple modes. The set of components that are used to support the multi-mode application may be different depending on which mode the multi-mode application 200 is operating in.

In FIG. 2, the components that support the operation of each mode are organized into logical containers. For instance, components 211A, 212A, 213A, 214A and 215A (which are organized into logical container 202A) support the operation of the multi-mode application 200 when operating in the first mode 201A. Components 211B, 212B, 213B, 214B, 215B and 216B (which are organized into logical container 202B) support the operation of the multi-mode application 200 when operating in the second mode 20TB. Components 211C, 212C, 213C, 214C and 215C (which are organized into logical container 202C) support the operation of the multi-mode application 200 when operating in the third mode 201C. The horizontal ellipses 202D represent that if there were other modes of operation (as represented by the horizontal ellipses 201D), there could be other corresponding logical containers for those other modes of operation as well.

In this description and in the claims, when components are described as being within a logical container or any other type of container, this does not mean that the components are necessarily included within a container. However, this does mean that the components are sufficiently associated with the container such that there is a set of one or more operations that, if performed on the container itself, are also performed on the associated components. For instance, the set of operations may include one, some, or all of the following operations:
1) an “activation” method in which the container (and thereby its constituent components) are made available to the multi-mode application;
2) a “deactivation” method in which the container (and thereby its constituent components) are made unavailable to the multi-mode application.

For instance, in order to activate a container, the components corresponding to the container may be loaded into memory (if not in memory already), and the logical container may have some logic which essentially dynamically “plugs into” or in other words makes available the constituent components to the multi-mode application. In order to deactivate a container, the logical container may intercede to unplug the constituent components from the multi-mode application. This may even be performed during execution of the multi-mode application at run-time. One technology that enables the plugging in of software components into and the unplugging of software components from a running application is called the Managed Extensibility Framework. However, the principles described herein are not limited to that mechanism.

As previously mentioned, each mode of the multi-mode application 200 is associated with a logical container that contains components that support the corresponding mode. While this is beneficial, the broadest principles described herein do not require that every single mode of a multi-mode application has a corresponding logical container. Benefit can still be obtained if only some of the modes have such a corresponding logical container. That said, the principles described herein can perhaps be used most advantageously if all modes have a corresponding container.

Although the logical containers 202A, 202B and 202C of FIG. 2 are illustrated as having a flat hierarchy, the same logical containers could be instead implemented hierarchically. For instance, FIG. 3 illustrates an example logical container hierarchy 300, although other hierarchies may also be used as well. The hierarchy 300 includes a standard container that includes a standard group of component(s) that are used across all modes of operation of the multi-mode application. For instance, suppose that components 312A, 312B and 312C are used across all modes 201A, 201B and 201C of FIG. 2. This might be the case if, for example, components 211A, 211B and 211C of FIG. 2 were the same as each other and the same as standard component 312A of FIG. 3, components 212A, 212B and 212C of FIG. 2 were the same as each other and the same as standard component 312B of FIG. 3, components 213A, 213B and 213C of FIG. 2 were the same as each other and the same as standard component 312C of FIG. 3. Perhaps no matter which mode is active, the standard container 311 may be accessible.

In addition to the standard container 311 that contains standard components used across all modes of operation, there are also mode-specific subcontainers 313A, 313B and 313C, each corresponding to a specific mode of operation such that the mode-specific subcontainer contains components that are specific to that mode of operation.

For instance, suppose that mode-specific containers 313A, 313B and 313C of FIG. 2 correspond to respective modes 201A, 201B and 201C of FIG. 2. The first mode-specific container 313A contains mode-specific components 214A and 215A that are specific to the mode 201A. The second mode-specific container 313B contains mode-specific components 214B, 215B and 216B that are specific to the mode 201B. The third mode-specific container 313C contains mode-specific components 214C and 215C that are specific to the mode 201C.

In this example, the first group of components within the logical container 202A is derived by inheriting the standard components 312A, 312B, 312C (which are the same as components 211A, 212A and 213A) from the standard container 311, and adding the mode-specific components 214A and 215A of the corresponding mode-specific container 313A. Likewise, the second group of components within the logical container 202B is derived by inheriting the standard components 312A, 312B, 312C (which are the same as components 211B, 212B and 213B) from the standard container 311, and adding the mode-specific components 214B, 215B and 216B of the corresponding mode-specific container 313B. Also, the third group of components within the logical container 202C is derived by inheriting the standard components 312A, 312B, 312C (which are the same as components 211C, 212C and 213C) from the standard container 311, and adding the mode-specific components 214C and 215C of the corresponding mode-specific container 313C.

In one embodiment, as new components are made available to the multi-mode application 200, those new components effectively assign themselves to the corresponding logical container. For example, the author of the component knows what the functionality of the component is, and what the functionality of the multi-mode application is. The author will know whether or not the functionality offered by the component is standard functionality (thereby being appropriately assigned to the standard container 311), or whether the functionality of the component is mode-specific functionality (thereby being appropriate assigned to one of the mode-specific containers 313A, 313B or 313C). In some cases, the components could be generic, and the user of the application (or perhaps some other heuristics) might thus choose which of the generic components to load.

For example, although the multi-mode application 200 may be any application that has multiple modes of operation, consider a concrete example of a text editor allows the user to interact with many different types of text files. For instance, suppose some of those text files may be particular source code files. Each mode of operation may correspond to a particular kind of text file and may be used when interacting through the text editor with a text file of that type.

There would be some standard set of functionality that should be available to a text editor regardless of the kind of text file being operated upon. For instance, the ability to display text, navigate through text, perform undo/redo actions, and the like, may be standard functionality. Accordingly, authors drafting components that accomplish this standard functionality may declare that the component is a standard component (thereby resulting in an assignment of the component to the standard container 311).

On the other hand, some functionality might be specific to a particular text file, and thus the corresponding mode that operates on that text file. For instance, suppose that the text editor operates on a particular source code file drafted in a particular source code language. There might be a syntax highlighter that scans through the existing text, identifies particular operators or data types, and highlights those data types to allow for more easy readability and understanding of the operation of the source code. Alternatively or in addition, there might be a compilation program that is specific to that particular source code language. All this functionality is specific to a particular programming language. If there were another type of source code file, another type of programming language would be used. The syntax highlighting and compilation functionality might be much different for that different programming language. Accordingly, if an author is constructing a component that is offering functionality specific to a particular text file type, the author may declare that component to be appropriate for a particular mode of operation (thereby resulting in an assignment of the component to the appropriate mode-specific container 313A, 313B or 313C).

In some cases, a component may be assigned to multiple modes. If the state of the component is not to be shared between those components, an instance of the component is established for each container. On the other hand, if the state of the components is to be shared, the same component instance may perhaps be included in multiple containers.

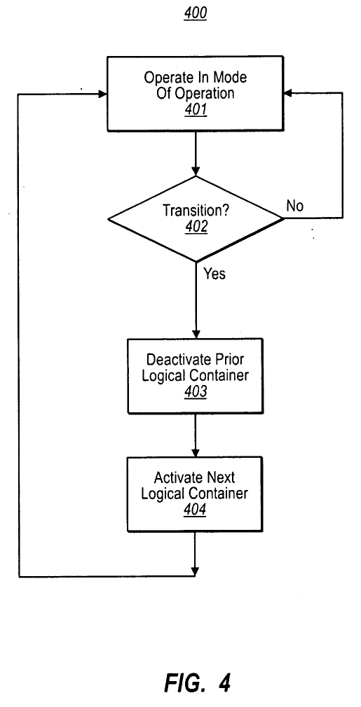

FIG. 4 illustrates a flowchart of a method 400 for transitioning from one mode of operation in a computer-executable application to another. The method 400 may be performed in the context of any multi-mode application that has corresponding logical containers that are each for having components that support a corresponding specific mode. In this context, the computing system (such as the computing system 100 of FIG. 1) logically organizes components used by a multi-mode application into a plurality of logical containers, at least some of the logical containers associated with a corresponding mode of operation of the multimode application. As an example, the method 400 will be described with some reference to the more specific multi-mode example of FIG. 2. Furthermore, the example of the text editor will sometimes be mentioned although the broader principles apply to any multi-mode application.

The description of the method 400 begins by assuming that the computing system operates the multi-mode application in a particular mode of operation (act 401). In that mode, a logical container associated with that particular mode of operation is active such that its constituent component(s) assist the multi-mode application while in the particular mode of operation. For example, referring to FIG. 2, if the multi-mode application 200 were in the mode 201A of operation, the logical container 202A might be active. In the text editor example, suppose that the text editor is editing a particular first type of text file.

If the multi-mode application does not transition to another mode (No in decision block), the multi-mode application continues in the same mode. However, if the multi-mode application is to transition to another mode (Yes in decision block 402), the computing system may respond by making preparations to transition the multi-mode application to the next mode of operation.

For instance, the multi-mode application may optionally deactivate the logical container associated with the prior mode of operation (act 403), and activate the logical container for the next mode of operation (act 404). The deactivation of the prior logical container may, but need not, involve removing the logical container and its constituent containers from memory. In any case, the deactivation means that the components of the prior logical container will not assist the multi-mode application in the next mode of operation by simple virtue of the components being included in the prior container. If, however, the component is also included in the logical container for the next mode of operation, that component will also assist in the next mode of operation by virtue of the component being included in the next logical container.

There might be a lifetime management functionality that looks for logical containers that have not been deactivated for some time, and perhaps unloads such logical containers from memory, or performs some other function appropriate given that the logical container is not used very often. For instance, for logical containers that are used often (for modes that are used often), when the mode is finished, perhaps the logical container is kept in memory in case the mode is to be returned to again in the near future. For logical containers that are not used often (for modes that are more rarely used), once that mode ends, the logical container may perhaps not only be deactivated, but also perhaps unloaded from memory altogether. Between those two extremes, there might be other logical containers that have a lifetime that depends on their historical frequency of use, load time, importance, and so forth. Thus, since components are logically organized into logical containers that each correspond to a mode, the frequency of use and other factors of the mode may be taken into consideration to more easily manage the logical containers.

In one embodiment, the computing system may also enforce atomicity of the components in the logical containers. For instance, the computing system might prevent inadvertent deletion of one of the components within a particular logical container if the other components are not also deleted. Since all of the components in a logical container may interact to provide the desired function for that mode, inadvertent deletion of a component in that container might adversely effect the operation of that entire mode. Since the components associated with a mode are neatly grouped into a single container, the mode functionality may be preserved by simply placing some safeguards at the logical container level. For instance, perhaps a component is not permitted to be deleted unless the deletion is part of a transaction in which a replacement component is provided to the logical container.

Once proper preparations have been made for the next mode of operation (via acts 403 and 404), the next mode of operation is engaged (returning to act 401 for the next mode). This process may continue for any number of subsequent modes. The application may thus transition from mode to mode, returning to modes when needed, and transitioning to other nodes when needed. For instance, whenever a mode transition is to occur (Yes in decision block 402) regardless of the number of prior mode transitions there were, the computing system prepares for the next mode of operation, and transitions to the next mode of operation.

Thus, a mechanism is described that more efficiently allows a multi-mode operation to load and unload appropriate components as the multi-mode application transitions from mode to mode. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for transitioning from one mode of operation in a computer-executable application to another, the method comprising:
an act of a computing system logically organizing a plurality of components used by a multi-mode application into a plurality of logical containers, at least some of the plurality of logical containers associated with a corresponding mode of operation of the multimode application;
an act of the computing system operating the multi-mode application in a prior mode of operation while a first logical container is active, the first logical container associated with the prior mode of operation and having a first group of component(s) that assist with the prior mode of operation;
an act of the multi-mode application transitioning from the prior mode of operation to a subsequent mode of operation;
in response to the act of the multi-mode application transitioning from the prior mode of operation to the subsequent mode of operation, performing the following:
an act of the computing system operating the multi-mode application in the subsequent mode of operating while a second logical container is active, the second logical container associated with the subsequent mode of operation and having a second group of component(s) that assists with the subsequent mode of operation, wherein at least one of the component(s) in the second group of component(s) is different than any component in the first group of component(s).

2. The method in accordance with claim 1, wherein the method further includes the following in response to the act of the multi-mode application transitioning from the prior mode of operation to the subsequent mode of operation:
an act of the computing system deactivating the first logical container.

3. The method in accordance with claim 2, wherein the act of the computing system deactivating the first logical container comprises:
an act of making the first group of component(s) unavailable for use by the multi-mode application while the multi-mode application is executing.

4. The method in accordance with claim 2, wherein the act of the computing system deactivating the first logical container comprises:
an act of unloading from memory the first group of component(s).

5. The method in accordance with claim 2, wherein the second container is inactive during the act of the computing system operating the multi-mode application in the prior mode of operation, wherein the method further includes the following in response to the act of the multi-mode application transitioning from the prior mode of operation to the subsequent mode of operation:
an act of the computing system activating the second logical container.

6. The method in accordance with claim 1, wherein the second container is inactive during the act of the computing system operating the multi-mode application in the prior mode of operation, wherein the method further includes the following in response to the act of the multi-mode application transitioning from the prior mode of operation to the subsequent mode of operation:
an act of the computing system activating the second logical container.

7. The method in accordance with claim 1, wherein the multi-mode application is a text editor.

8. The method in accordance with claim 7,
wherein the first mode of operation is the text editor when interacting with a first kind of text file, and
wherein the second mode of operation is the text editor when interacting with a second kind of text file.

9. The method in accordance with claim 8,
wherein one of the component(s) in the first group of components is for performing text highlighting for the first kind of text file, and
wherein one of the component(s) in the second group of components is for performing text highlighting for the second kind of text file.

10. The method in accordance with claim 1, further comprising:
an act of the multi-mode application transitioning from the subsequent mode of operation to a next subsequent mode of operation;
in response to the act of the multi-mode application transitioning from the subsequent mode of operation to the next subsequent mode of operation, performing the following:
an act of the computing system deactivating the second logical container; and
an act of the computing system operating the multi-mode application in the next subsequent mode of operating while a third logical container is active, the third logical container associated with the next subsequent mode of operation and having a third group of component(s) that assists with the next subsequent mode of operation, wherein at least one of the component(s) in the third group of component(s) is different than any component in the second group of component(s).

11. The method in accordance with claim 10, wherein the third container is inactive during the act of the computing system operating the multi-mode application in the subsequent mode of operation, wherein the method further includes the following in response to the act of the multi-mode application transitioning from the subsequent mode of operation to the next subsequent mode of operation:
an act of the computing system activating the third logical container.

12. The method in accordance with claim 1, wherein the act of the computing system logically organizing a plurality of components used by a multi-mode application into a plurality of logical containers comprises:
an act of maintaining a standard container that includes a standard group of component(s) that are used across all modes of operation of the multi-mode application.

13. The method in accordance with claim 12, wherein the act of the computing system logically organizing a plurality of components used by a multi-mode application into a plurality of logical containers further comprises:
an act of maintaining a plurality of mode-specific subcontainers that each correspond to a corresponding mode of operation of the multi-mode application.

14. The method in accordance with claim 13, wherein the first group of component(s) is derived from the standard container and from a first mode-specific subcontainer of the plurality of the mode-specific subcontainers.

15. The method in accordance with claim 14, wherein the second group of component(s) is derived from the standard container and from a second mode-specific subcontainer of the plurality of the mode-specific subcontainers.

16. A computer program product comprising one or more physical computer-readable media having thereon the following:
computer-executable instructions that cause the computing system to logically organize a plurality of components used by a multi-mode application into a plurality of logical containers, at least some of the plurality of logical containers associated with a corresponding mode of operation of the multimode application;
prior mode computer-executable instructions that causes the computing system to operate the multi-mode application in a prior mode of operation while a first logical container is active, the first logical container associated with the prior mode of operation and having a first group of component(s) that assist with the prior mode of operation; and
subsequent computer-executable instructions that are executed in response to the detection that the multi-mode application is to transition to a subsequent mode of operation, and that cause the computing system to operate the multi-mode application in the subsequent mode of operating while a second logical container is active, the second logical container associated with the subsequent mode of operation and having a second group of component(s) that assists with the subsequent mode of operation, wherein at least one of the component(s) in the second group of component(s) is different than any component in the first group of component(s).

17. A method for transitioning a text editor from a first mode for editing a first text file type to a second mode for editing a second text file type.
an act of a computing system logically organizing a plurality of components used by the text editor into a plurality of logical mode-specific containers;
an act of the computing system operating the text editor in a prior mode of operation in which a text file of the first text file type is being edited and while a first logical container is active, the first logical container associated with the prior mode of operation and having a first group of component(s) that associated with the prior mode of operation;
an act of the text editor detecting that the second text file type is loaded for editing by the text editor;
an act of the text editor transitioning from the prior mode of operation to a subsequent mode of operation in response to the act of the text editor detecting that the second text file type is loaded for editing by the text editor;
in response to the act of the text editor transitioning from the prior mode of operation to the subsequent mode of operation, performing the following:
an act of the computing system operating the text editor in the subsequent mode of operating while a second logical container is active, the second logical container associated with the subsequent mode of operation and having a second group of component(s) that assists with the subsequent mode of operation, wherein at least one of the component(s) in the second group of component(s) is different than any component in the first group of component(s).

18. The method in accordance with claim 17,
wherein one of the component(s) in the first group of components is for performing text highlighting for the first text file type, and
wherein one of the component(s) in the second group of components is for performing text highlighting for the second text file type.

19. The method in accordance with claim 18, wherein the first text file type is a first type of computer program file type.

20. The method in accordance with claim 19, wherein the second text file type is a second type of computer program file type.
